(19) United States
(12) Patent Application Publication
(10) Pub. No.: US 2011/0288859 A1
(43) Pub. Date: Nov. 24, 2011

(54) LANGUAGE CONTEXT SENSITIVE COMMAND SYSTEM AND METHOD

(76) Inventors: Andrew E. Taylor, Barre, MA (US); Jeffrey P. Ganyard, Incline Village, NV (US); Paul M. Herzog, Burlington, VT (US)

(21) Appl. No.: 13/017,914

(22) Filed: Jan. 31, 2011

Related U.S. Application Data
(60) Provisional application No. 61/301,883, filed on Feb. 5, 2010.

(51) Int. Cl. G10L 21/00; G10L 15/00

(52) U.S. Cl. 704/231; 704/275; 704/E15.003; 704/E21.001

(57) ABSTRACT

A system and method implements a command system in a speech recognition context in such a way as to enable a user to speak a voice command in a first spoken language to a computer that is operating an application in a second spoken language configuration. The command system identifies the first spoken language the user is speaking, recognizes the voice command, identifies the second spoken language of a target application, and selects the command action in the second spoken language that correlates to the voice command provided in the first spoken language.

### RELATED APPLICATION

This application claims priority to, and the benefit of, co-pending U.S. Provisional Application No. 61/301,883, filed Feb. 5, 2010, for all subject matter common to both applications. The disclosure of said provisional application is hereby incorporated by reference in its entirety.

### FIELD OF THE INVENTION

The present invention relates to a voice command system and method that is language context sensitive, and more particularly to a voice command system and method suitable for receiving voice commands in a first spoken language and implementing them on a computer running an application configured for a different second spoken language.

### BACKGROUND OF THE INVENTION

Speech recognition and voice processing systems are known for translation of dictated speech into text or computer instructions (such as menu operations, and the like). Conventional speech recognition systems use a number of different algorithms and technologies in a perennial effort to recognize a user's speech and do what the user desires based on that speech recognition. A common application of this technology is in the classic dictation sense, where voice is converted into text in a word processing application. Another application is conversion of voice into common instructions or commands for menu operations, such as open a file, close a file, save a file, copy, paste, etc., or other commands that cause the implementation of tasks by applications executing or operating on a computing device.

In most systems, the computing device includes memory, storage, and one or more processors, that execute a software application enabling the speech recognition functionality. A user speaks into a microphone and the speech recognition software processes the user's voice signal into text or commands.

With regard to the conversion of voice into common instructions for menu operations, in speech recognition systems and methods, there are often implementations that enable a user to provide commands to a computer using only, or primarily, their voice. A typical command and control system executes only in one spoken language. The command name provided by the user is bound to a single action that is expressed in the same language of the command name. What this means is that if a user speaks a first spoken language, such as German for example, and the spoken language for which the active application executing or operating on the user's computer is configured is English, any voice commands issued by the user in German will not be recognized or be operable with the active application in its English configuration.

There are some circumstances in which the command may be implemented in a language independent manner. However, this does not work in all instances. Accordingly, the user that desires to issue voice commands to an application executing or operating on a computer, must issue the voice command in whatever language for which the computer and application are configured. As such, if the user is speaking in a first spoken language in the context of for example, a dictation, the user is forced to switch languages and speak in a second spoken language to issue any voice commands to a system configured for that second spoken language. This can be highly disruptive to the productivity of the user to have to switch back and forth between multiple languages.

### SUMMARY

There is a need for a command system and method that enables a user to provide voice commands in any of a plurality of spoken languages regardless or independent of the language configuration for the computer implementing the commands. The present invention is directed toward further solutions to address this need, in addition to having other desirable characteristics.

In accordance with one embodiment of the present invention, a computer-implemented method includes identifying a command trigger indicating a command, the command trigger defined in a first spoken language from a received verbal signal. A command action associated with the command is identified, the command action defined in a second spoken language from a received verbal signal. A target application executing in the second spoken language on one or more processors is instructed to complete a task in compliance with the command action, the first spoken language and the second spoken language being distinct from each other.

In accordance with aspects of the present invention, the first spoken language matches a spoken language of a user voice profile. The command trigger can be a command name. The command trigger can include a required argument. The command trigger can include an optional argument. The command trigger can include a spoken language identification label. The command action can include one or more execution units. The command action can include one or more data units. The command action can include one or more additional command actions, in such a way as to result in execution of a plurality of actions. The command action can include a spoken language identification label. The first spoken language can be automatically identified. The second spoken language can be automatically identified. The command action can be monitored, and a synonymic command action phrase can be identified. The second spoken language can match a configuration of the computer implementing the target application. The second spoken language can be defined within a user profile.

In accordance with one example embodiment of the present invention, a computer-readable storage medium, which is not a signal, with an executable program stored thereon, is provided. The program contains instructions to perform a plurality of steps, including identifying a command trigger indicating a command, the command trigger defined in a first spoken language from a received verbal signal. The method may further include identifying a command action associated with the command, the command action defined in a second spoken language from a received verbal signal. The method may further include instructing a target application executing in the second spoken language on one or more processors to complete a task in compliance with the command action, the first spoken language and the second spoken language being distinct from each other.

In accordance with one example embodiment of the present invention, a speech recognition based command system, includes a speech recognition software application operating on a computing device having a microprocessor. The speech recognition software application can include a speech recognition engine. A command trigger identification mechanism can be configured to identify a command trigger indicating a command, the command trigger defined in a first spoken language from a received verbal signal. A command action identification mechanism can be configured to identify a command action associated with the command, the command action defined in a second spoken language from a received verbal signal. An instruction generator can be configured to instruct a target application executing in the second spoken language on one or more processors to complete a task in compliance with the command action, the first spoken language and the second spoken language being distinct from each other.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of components forming a speech recognition command system, according to one embodiment of the present invention;

FIG. 2 is a flowchart illustrating operation of the system and method of implementing a voice command, according to one aspect of the present invention;

FIG. 3 is a flowchart illustrating operation of the system and method of implementing a voice command, according to one aspect of the present invention; and

FIG. 4 is a diagrammatic illustration of a computer system capable of operating the system and method, according to one aspect of the present invention.

### DETAILED DESCRIPTION

An illustrative embodiment of the present invention relates to a speech recognition command system and method that enables a user to speak a first spoken language to issue a voice command, and have a computer configured to operate in a second spoken language execute the command, despite being configured for a different spoken language than that which was spoken by the user issuing the voice command. This is accomplished in accordance with the present invention most preferably by separating a voice command into two components, a command trigger and a command action. The command trigger relates to the one or more words or phrases that are spoken by a user to cause a command to operate. The command action provides one or more execution units associated with a different operating mode configuration language for the target application. Structuring a voice command into two components enables the two components to exist in different spoken language configurations.

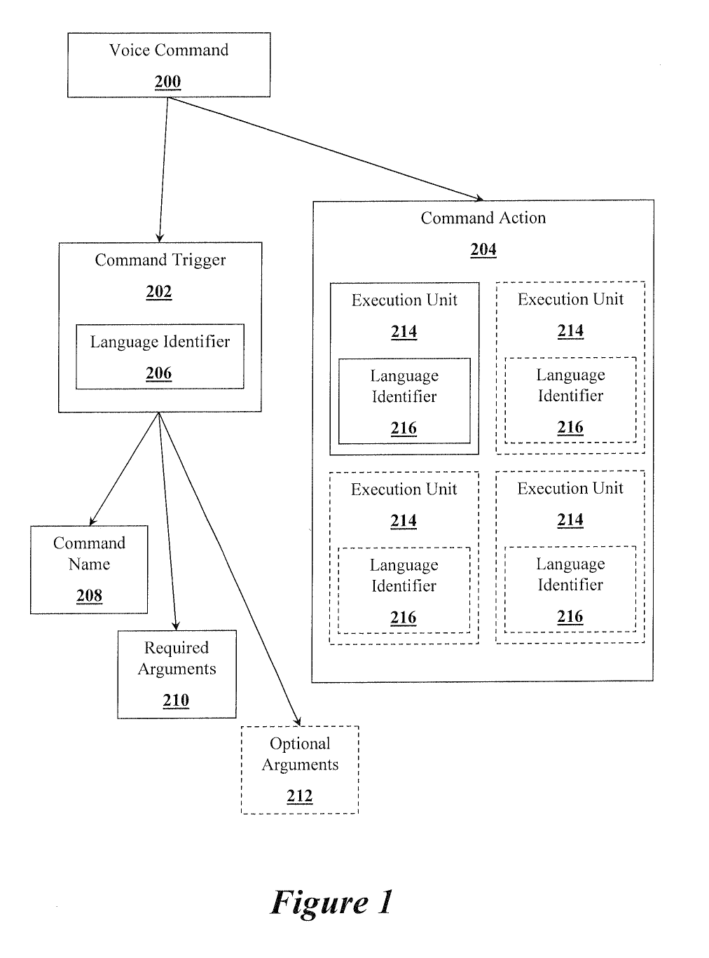

FIGS. 1 through 4, wherein like parts are designated by like reference numerals throughout, illustrate an example embodiment of a speech recognition command system and method according to the present invention. Although the present invention will be described with reference to the example embodiment illustrated in the figures, it should be understood that many alternative forms can embody the present invention. One of ordinary skill in the art will additionally appreciate different ways to alter the parameters of the embodiments disclosed, in a manner still in keeping with the spirit and scope of the present invention.

FIG. 1 is a diagrammatic illustration of components forming the system and method of the present invention. In accordance with various embodiments of the present invention, a voice command 200 provided by a user is separated into two components, a command trigger 202 and a command action 204.

The command trigger 202 contains one or more words or phrases that identify what a user would say to cause the command to operate or execute. The command trigger 202 words or phrases may be in one of a number of different spoken languages. Each command trigger 202 has a language identifier 206 associated therewith. The language identifier 206 can be used by a speech recognition system to sort and identify words and phrases belonging to a particular spoken language, once that language has been identified by the speech recognition system, or selected by the user. For example, if the user is speaking in English, each command trigger 202 word or phrase having an “English” language identifier 206 can be loaded into a list of possible words or phrases forming command triggers 202. In operation, as later described, this pre-loading of possible words or phrases improves the speed with which the word command trigger 202 is implemented by the system and method of the present invention.

The command trigger 202 can be further dissected into three components, namely, a command name 208, required argument(s) 210, and optional argument(s) 212. Each of the command name 208, required argument(s) 210, and optional argument(s) 212 can take the form of a word or words, or phrase or phrases.

The command name 208 is the word or phrase that a user provides to cause the command to operate or execute. Example words or phrases include, but are not limited to, “move”, “select”, “page”, “find”, “open”, “activate”, “close”, “access”, “create”, “hide”, “show”, “save”, “press”, “type”, “click”, “launch”, “reveal”, “display”, “double click”, “jump”, “train”, and the like. The command name 208 provides the basic information necessary for the command system to identify which command the user wishes to execute.

The required argument(s) 210 are the words or phrases that may be required by particular command names 208, depending on the command desired. Example words or phrases include, but are not limited to, “up”, “down”, “left”, “right”, and the like. The required argument(s) 210 provide the basic information necessary for the command system to implement the previously identified command name 208. For example, if the command name 208 uttered by a user is “move”, such a command would also need the required argument(s) 210 indicating a direction in order to complete the desired task. So, the complete command would be a combination of the command name 208 and the required argument(s) 210, namely, “move up”, or “move down”, “move forward”, “move backward”, or the like.

In addition to or instead of the required argument(s) 210 there may be optional argument(s) 212. For example, a “move” command may normally operate on word units within a document generated on a word processor (i.e., each move in a particular direction would move the cursor to the beginning of another word (word-by-word basis), not to a character in the middle of a word). However, if the user specifies the optional arguments of “<num> characters”, then the command would move on a character-by-character basis in the requested direction by the number of characters specified. It is desirable to be flexible in command recognition with respect to normal grammatical accuracy. Therefore, in various spoken languages, there may be more than one variation of these arguments. For example, in English, the phrases “two characters” or “twelve pages” are acceptable and grammatically correct. In contrast, although the phrases “one characters” and “one lines”, and the like, are grammatically incorrect, they are still recognized and accepted as a valid command. In the example command of “move”, the default required argument is “words” without the user specifying “words”. However, the user can also say “words” when issuing the command, if desired. This will have no altered effect because it is the default condition. As would be understood by one of ordinary skill in the art, the above explanation is merely illustrative of numerous different and varying combinations of commands, required arguments, and optional arguments. As such, the present invention is by no means limited to only the examples described herein. Rather, the present invention anticipates all forms and combinations of commands and arguments that can be contemplated to be operable in accordance with the present invention. Variations, such as those describing general plurality, are equivalently recognizable, even if they violate language specific grammar rules and common usage patterns. It should be noted that, as would be understood by those of ordinary skill in the art, when triggering commands, the particular grammar is not as important as the need to attempt to execute what is decipherable from the command given, regardless of whether it fits an exact phrase or grammar.

In further example of arguments, representative arguments for a command can include static enumerations, such as specific ranges of numbers, e.g., 1 to 10, or 0 to 99, or ordered sets of letters in an alphabet. Dynamically generated lists like the names or e-mail addresses of all contacts, or all buttons or other GUI controls found in a window, lists of most recently used documents, or recently visited URLs, the list of filenames in a particular directory (or the currently active directory window), and other lists of items either statically generated or dynamically generated can be used to form arguments for use with the present invention. The static enumerations and the dynamically generated lists can be generated in accordance with conventional practices for list generation, as would be understood by those of ordinary skill in the art. As such, further detail on such list generation is not provided herein. The present invention makes use of such lists to reference when matching arguments with voice commands. As such, the actual formation of the lists is ancillary to the system and method of handling voice commands in accordance with the present invention.

The command action 204 contains one or more execution units 214 (one execution unit 214 being shown in solid line and optional additional execution units 214 being shown in dashed line in FIG. 1), each associated with a different operating mode language for the target application. The actual number of execution unit(s) 214 of the one or more execution units 214 depends upon the particular command action 204 being implemented and the requisite number of execution unit(s) 214 required to carry out the command action 204. Because there are too many potential forms of command actions 204, specifics on the numbers of execution units 214 required are not possible. One of ordinary skill in the art, given the teaching of the present disclosure, will readily be able to determine the number of execution units 214 required for each command action 204, as well as the sequencing and timing of the execution units 214. Accordingly, the present invention anticipates use of one or more execution units 214 in association with particular command actions 204 and determined by the particular command action 204 being implemented.

Each execution unit 214 has a language identifier 216 associated therewith. The language identifier 216 can be used by the command system to implement the execution unit belonging to a particular spoken language corresponding to the contemporaneous operating mode language of the target application, once that language has been identified by the speech recognition system, or selected by the user. For example, regardless of the language spoken by the user, if the target application is operating in an English language configuration, each execution unit 214 having an “English” language identifier 206 can be loaded into a list of likely execution units 214 that could be sent to the target application in the language configuration of that target application as a task instruction or command. As discussed previously with regard to the generation of lists for required arguments 210 and optional arguments 212, the lists for execution units 214 can likewise be static or dynamically generated in accordance with conventional list generation practices.

The execution unit(s) 214 can cause many different activities to occur, as limited only by the commands that can be implemented by a target application or operating system, as would be understood by one of ordinary skill in the art. For example, the execution unit(s) 214 may include typing text contained in the execution unit, pressing keystrokes with accompanying modifier keys, pressing buttons or operating other computer user interface elements, executing AppleScript or other types of scripts, displaying images, playing sound files, opening web pages, opening other kinds of files, activating applications, operating menus, and any other kind of activity that can be executed on a computer by a target application or operating system. As part of the process of invoking a command trigger 202, the user may specify optional or required arguments to the command trigger 202 as discussed above. These arguments 210, 212 are provided to the execution unit(s) 214 to further direct activities in the process of executing the command action 204. The implementation of an execution unit 214 may include lists of data elements that are referred to in some fashion by the required or optional arguments 210, 212. Examples of these data units are: a list of e-mail addresses indexed by name or number and/or other categorization, a list of sound files, a list of image files, lists of other kinds of files, lists of commands, numeric, or alphabetic values. Through similar arguments it is possible for a user to specify that an action invoke yet another action upon a particular list of items, generating multiple levels of activities from a single user voice command 200.

It should be noted that multiple actions can be chained together, and composed to enable more complex interactions to occur within a single target application, as would be understood by those of ordinary skill in the art given the description provided herein. Actions, initiated by a simple or complex voice command 200 are not restricted to a single application, and may result in one or more sub-actions to be launched concurrently, and/or sequentially within separate applications. These sub-actions may require precise timing and management by the command system including inter-process communication techniques to properly handle execution dependencies amongst the sub-actions.

Finally, the command system in accordance with the present invention can automatically identify the spoken language provided by the user, and spoken language configuration of the target application. The actual recognition of the words and phrases spoken by the user is conducted by the speech recognition engine, which after receiving a sufficient amount of voice signal data (an amount that differs by engine) can take the identified words and determine to which language all of the words belong. Thus, the language is determined by the speech recognition engine, as is conventional and known to those of ordinary skill in the art. The command system of the present invention, in an automated fashion, then obtains this language information from the speech recognition engine and ensures that the same language is used when attempting to match the voice command 200 to a set of command triggers 202 available in the particular spoken language. The command system also obtains system configuration information or application configuration information from the target application, indicating that the computer operating the target application is operating in a particular spoken language configuration. The command system is then able to select from command actions 204 available in the correct spoken language for each command action 204 that is forwarded to the target application. The command system may alternatively use settings provided by the user via either commands or a preference to select the correct language for each component when executing. Further alternatively, the command system may rely on identification of a user profile, with a corresponding language identifier.

In accordance with one example embodiment of the command system of the present invention, a database configuration is utilized to manage the lists of command triggers, command actions, and language identifiers. The example database structure may contain a table of voice commands 200, each command identified by a unique identifier, and can be associated with one or more versions of a specific application, or be general purpose, operable with any application. Each voice command 200 entry in the database can have several tables associated with it to identify the major components of the voice command 200. For example, there may be a table for the command triggers 202, a table for the command actions 204, and additional tables to identify items such as required or optional arguments 210, 212 for the command trigger(s) 202. The presence of required and/or optional arguments for a command trigger 202 may generate the need for additional tables to contain the data necessary to execute the command. Some of these tables may be statically generated and in other cases may be dynamically generated depending upon other external events, as a result of evaluating command arguments, or as a result of the need to execute the command.

In accordance with another example embodiment of the command system of the present invention, the system may be implemented using a simple set of data structures whose complexity is dictated by how much of the above described activities are actually implemented. Many of the details can be built into the executing program with little allowance for options or variants, as would be understood by those of ordinary skill in the art. The example data structures may consist of a hash map of voice commands 200, each command identified by a unique identifier, which additionally serves as the hash key and can be associated with one or more versions of a specific application, or be general purpose, operable with any application. Each voice command 200 entry in the hash map can have linked lists associated with it to identify the major components of the voice command 200. For example, there may be a linked list for the command triggers 202, a linked list for the command actions 204, and additional linked lists to identify items, such as required or optional arguments 210, 212, for the command trigger(s) 202. The presence of required and/or optional arguments for a command trigger 202 may generate the need for additional linked lists and/or hash maps to contain the data necessary to execute the command. Some of these tables may be statically generated, and in other cases may be dynamically generated, depending upon other external events, as a result of evaluating command arguments, or as a result of the need to execute the command.

As described previously, one example embodiment of the present invention makes use of an automatic an identification of the spoken language provided in the voice command as obtained through a synchronization with the speech engine, and an identification of the spoken language provided in configuration of the target application and the computer upon which it executes. In accordance with yet another embodiment of the present invention, a command, preference, or some other action that specifies the language to use for the spoken command trigger 202 and another indicator to specify what language to use for the command action 204 may be provided by the user. The user can then specify directly the spoken languages, and the alternative identification is not required. These settings can be provided, for example, globally, on a per-voice profile level, or on a per-target application level, as would be understood by those of ordinary skill in the art.

In accordance with further aspects of the present invention, voice command system and method can monitor usage of the various command forms and identify preferred synonym phrases for the speaker. As each command trigger may be recognized by more than one phrase, these phrases are distinguished from one another through the use of semantically equivalent phrases. For example, the English phrases for sending an email might be “email Mary the current file”, “send mail to Mary containing the front-most document”, “mail Mary this document”, “send a message to Mary with the current file”, and the like. These variations are referred to as synonym phrases, and their recognition results in the same sequence of events for determining the action to be executed, and furthermore will result in the same action or task being executed. The voice command system and method can monitor which of these various command forms are most often used by the speaker, thereby designating preferred synonym phrases. These preferred synonym phrases can be applied dynamically to extend the command grammars uniquely for each speaker and thereby enable a greater range of command recognition. Continuing with the example, for other commands that the word “mail”, “email”, or “message” appears in the trigger phrase, the preferred synonym (as inferred dynamically) could be utilized, even if these synonyms were not explicitly specified for these other commands. Rather than having to learn a specific and strict phraseology for a command, the command system will infer the command phrases based on previously recognized commands. Effectively, the command triggers adapt to alternative forms that a user might issue if they do not remember the standard command form.

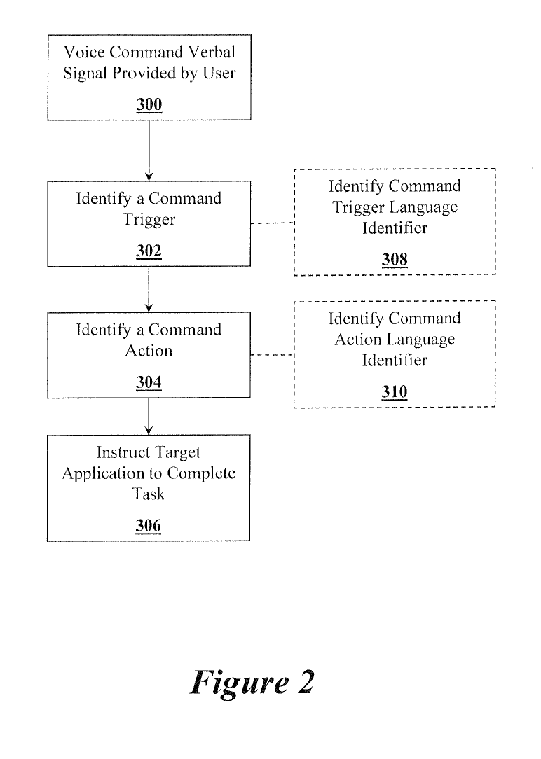

In operation, the voice command system and method of the present invention can be implemented on a computer or within a computing environment. For example, as shown in FIG. 2, an exemplar method for a user to interact with the voice command system can begin with a user uttering a verbal signal voice command 200 (step 300). The voice command system receives the verbal signal voice command, and attempts to identify a command trigger 202 (step 302). In accordance with the present invention, the voice command system can optionally identify a command trigger language identifier 206 with the command trigger 202 (step 308). The identification of a command trigger language identifier 206 is indicated as being optional, because the process of separating a voice command into two components (command trigger and command action) has no requirement that each component be aware of or relate to a particular language. However, in the instance in which the present invention provides a seamless capability of a user to interact with a target application or computer using a different spoken language than the spoken language for which the target application or computer are configured, such a process does require identification of the command trigger language identifier 206. As such, in the context of such an implementation, the identification of language identifiers would not be optional. The voice command system then attempts to identify a command action 204 (step 304). If the voice command system is unable to identify a command trigger 202 or a command action 204, then the process aborts. However, assuming the voice command system identifies a command trigger 202 and a command action 204 based on the voice command 200 received, the voice command system then instructs a target application executing on a processor to complete a task in compliance with the command action 204 (step 306). In accordance with the present invention, the voice command system can optionally identify a language identifier 216 with the command action 204 (step 310). The identification of language identifier 216 is indicated as being optional, because the process of separating a voice command into two components (command trigger and command action) has no requirement that each component be aware of or relate to a particular language. However, in the instance in which the present invention provides a seamless capability of a user to interact with a target application or computer using a different spoken language than the spoken language for which the target application or computer are configured, such a process does require identification of the language identifier 216. As such, in the context of such an implementation, the identification of language identifiers would not be optional.

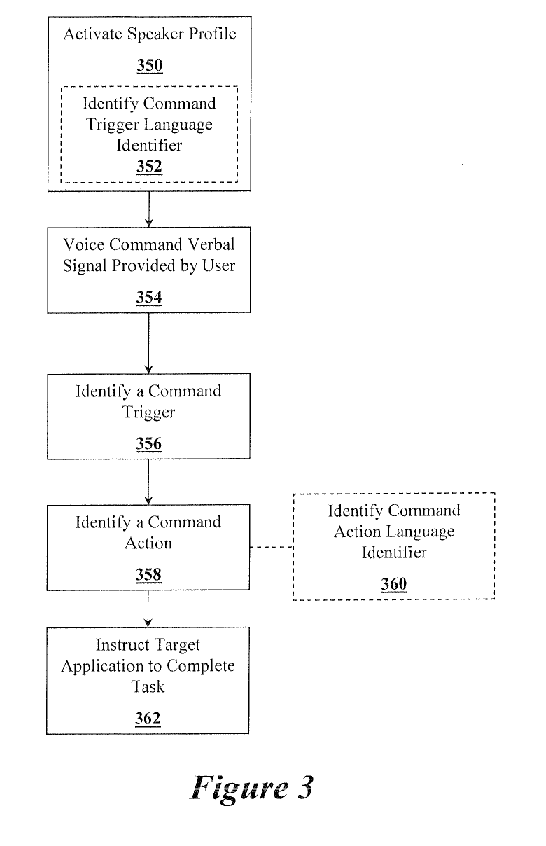

Alternatively, in operation, the voice command system and method of the present invention can be implemented as shown in FIG. 3, an exemplar method for a user to interact with the voice command system can begin with activation of a speaker profile (step 350). Together with the activation step, the voice command system can optionally identify a command trigger language identifier (step 352), as described above with regard to when such an option would be exercised. A verbal signal voice command 200 is provided by the user (step 354). The voice command system receives the verbal signal voice command, and attempts to identify a command trigger 202 (step 356). The voice command system then attempts to identify a command action 204 (step 358). If the voice command system is unable to identify a command trigger 202 or a command action 204, then the process aborts. However, assuming the voice command system identifies a command trigger 202 and a command action 204 based on the voice command 200 received, the voice command system then instructs a target application executing on a processor to complete a task in compliance with the command action 204 (step 362). In accordance with the present invention, the voice command system can optionally identify a language identifier 216 with the command action 204 (step 360). The identification of language identifier 216 is optional, for the same reasons stated above in the prior example.

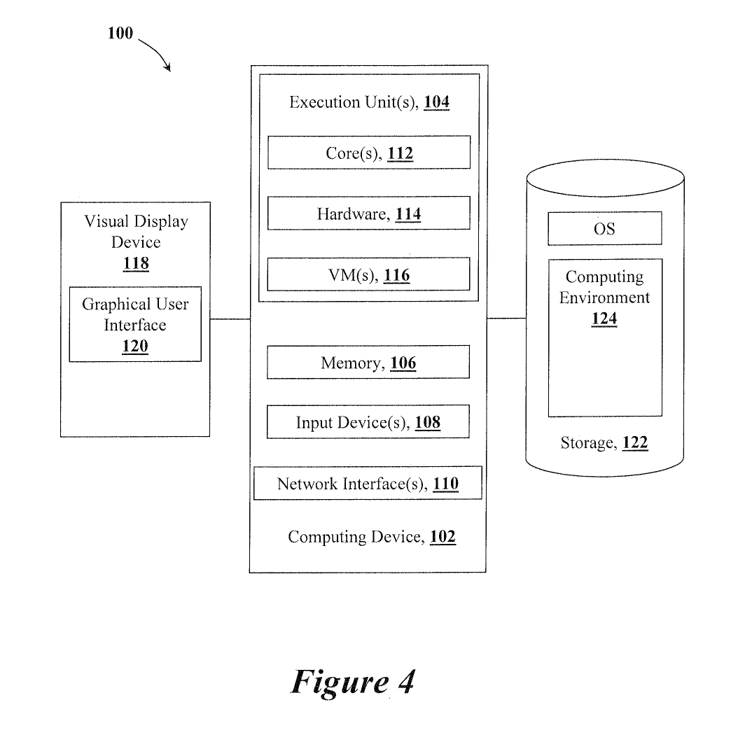

FIG. 4 depicts a computing environment 100 suitable for practicing exemplary embodiments of the present invention. As indicated herein, the present system and method can be implemented on a computing device 102 operating the speech recognition software application. The computing environment 100 includes the computing device 102, which may include execution units 104, memory 106, input device(s) 108, and network interface(s) 110. The execution units 104 may include hardware or software based logic to execute instructions on behalf of the computing device 102. For example, depending on specific implementation requirements, execution units 104 may include: one or more processors, such as a microprocessor; single or multiple cores 112 for executing software stored in the memory 106, or other programs for controlling the computing device 102; hardware 114, such as a digital signal processor (DSP), a graphics processing unit (GPU), a field programmable gate array (FPGA), an application specific integrated circuit (ASIC), etc., on which at least a part of applications can be executed; and/or a virtual machine (VM) 116 for executing the code loaded in the memory 106 (multiple VMs 116 may be resident on a single execution unit 104).

Depending on specific implementation requirements, the memory 106 may include a computer system memory or random access memory (RAM), such as dynamic RAM (DRAM), static RAM (SRAM), extended data out RAM (EDO RAM), etc. The memory 106 may include other types of memory as well, or combinations thereof. A user may interact with the computing device 102 through a visual display device 118, such as a computer monitor, which may include a graphical user interface (GUI) 120. Users with visual impairment may also utilize screen readers and/or voice or other audio or sensory stimulus that can convey what is appearing (or would normally appear) on a visual display device. The computing device 102 may include other I/O devices, such as a keyboard, and a pointing device (for example, a mouse) for receiving input from a user. Optionally, the keyboard and the pointing device may be connected to the visual display device 118. The computing device 102 may include other suitable conventional I/O peripherals. Moreover, depending on particular implementation requirements of the present invention, the computing device 102 may be any computer system such as a workstation, desktop computer, server, laptop, handheld computer or other appropriate form of computing or telecommunications device that is capable of communication and that has sufficient processor power and memory capacity to perform the operations described herein.

Additionally, the computing device 102 may include interfaces, such as the network interface 110, to interface to a Local Area Network (LAN), Wide Area Network (WAN), a cellular network, the Internet, or another network, through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), synchronous transfer mode (STM), wireless connections (e.g., 802.11), high-speed interconnects (e.g., InfiniBand, gigabit Ethernet, Myrinet) or some combination of any or all of the above as appropriate for a particular embodiment of the present invention. The network interface 110 may include a built-in network adapter, network interface card, personal computer memory card international association (PCMCIA) network card, card bus network adapter, wireless network adapter, universal serial bus (USB) network adapter, light peak network adapter, modem or any other device suitable for interfacing the computing device 102 to any type of network capable of communication and performing the operations described herein.

The computing device 102 may further include a storage device 122, such as a hard-drive, flash-drive, or CD-ROM, for storing an operating system (OS) and for storing application software programs, such as computing application environment 124 executing the embodiment(s) of the present invention. The computing application environment 124 may run on any operating system such as any of the versions of the conventional operating systems, any embedded operating system, any real-time operating system, any open source operating system, any proprietary operating system, any operating systems for mobile computing devices, or any other operating system capable of running on the computing device and performing the operations described herein. Furthermore, the operating system and the computing environment 124 may in some instances be run from a bootable storage device (like CD, DVD, Blu-ray, flash memory, and the like).

One of ordinary skill in the art will appreciate that the above description concerning the computing environment 100 and computing device 102 is intended to encompass all conventional computing systems suitable for carrying out methods of the present invention. As such, any variations or equivalents thereof that are likewise suitable for carrying out the methods of the present invention are likewise intended to be included in the computing environment 100 described herein. Furthermore, to the extent there are any specific embodiments or variations on the computing environment 100 that are not suitable for, or would make inoperable, the implementation of the present invention, such embodiments or variations are not intended for use with the present invention.

The computing device 102 may run software applications, including voice or speech recognition software applications, such as, for example, MacSpeech® Dictate speech recognition software. Other speech recognition software applications can operate on the computing device 102, as would be understood by those of ordinary skill in the art. As such, the present invention is not limited to use only the applications named herein as illustrative examples.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computer-implemented method, comprising:
identifying a command trigger indicating a command, the command trigger defined in a first spoken language from a received verbal signal;
identifying a command action associated with the command, the command action defined in a second spoken language from a received verbal signal; and
instructing a target application executing in the second spoken language on one or more processors to complete a task in compliance with the command action, the first spoken language and the second spoken language being distinct from each other.

2. The method of claim 1, wherein the first spoken language matches a spoken language of a user voice profile.

3. The method of claim 1, wherein the command trigger comprises a command name, a required argument, an optional argument, a spoken language identification label, or any combination thereof.

4. The method of claim 1, wherein the command action comprises one or more execution units, data units, additional command actions in such a way as to result in execution of a plurality of actions, spoken language identification labels, or any combination thereof.

5. The method of claim 1, wherein the first spoken language, the second spoken language, or both, are automatically identified.

6. The method of claim 1, further comprising monitoring the command action and identifying a synonymic command action phrase.

7. The method of claim 1, wherein the second spoken language matches a configuration of the computer implementing the target application.

8. The method of claim 1, wherein the second spoken language is defined within a user profile.

9. A computer-readable storage medium, which is not a signal, with an executable program stored thereon, wherein the program contains instructions to perform a method, the method comprising:
identifying a command trigger indicating a command, the command trigger defined in a first spoken language from a received verbal signal;
identifying a command action associated with the command, the command action defined in a second spoken language from a received verbal signal; and
instructing a target application executing in the second spoken language on one or more processors to complete a task in compliance with the command action, the first spoken language and the second spoken language being distinct from each other.

10. The computer-readable storage medium of claim 9, wherein the first spoken language matches a spoken language of a user voice profile.

11. The computer-readable storage medium of claim 9, wherein the command trigger comprises a command name, a required argument, an optional argument, a spoken language identification label, or any combination thereof.

12. The computer-readable storage medium of claim 9, wherein the command action comprises one or more execution units, data units, additional command actions in such a way as to result in execution of a plurality of actions, spoken language identification labels, or any combination thereof.

13. The computer-readable storage medium of claim 9, wherein the first spoken language, the second spoken language, or both, are automatically identified.

14. The computer-readable storage medium of claim 9, further comprising monitoring the command action and identifying a synonymic command action phrase.

15. The computer-readable storage medium of claim 9, wherein the second spoken language matches a configuration of the computer implementing the target application.

16. The computer-readable storage medium of claim 9, wherein the second spoken language is defined within a user profile.

17. A speech recognition based command system, comprising:
a speech recognition software application operating on a computing device having a microprocessor, the speech recognition software application comprising:
a speech recognition engine;
a command trigger identification mechanism configured to identify a command trigger indicating a command, the command trigger defined in a first spoken language from a received verbal signal;
a command action identification mechanism configured to identify a command action associated with the command, the command action defined in a second spoken language from a received verbal signal; and
an instruction generator configured to instruct a target application executing in the second spoken language on one or more processors to complete a task in compliance with the command action, the first spoken language and the second spoken language being distinct from each other.

18. The system of claim 17, wherein the first spoken language matches a spoken language of a user voice profile.

19. The system of claim 17, wherein the command trigger comprises a command name, a required argument, an optional argument, a spoken language identification label, or any combination thereof.

20. The system of claim 17, wherein the command action comprises one or more execution units, data units, additional command actions in such a way as to result in execution of a plurality of actions, spoken language identification labels, or any combination thereof.

21. The system of claim 17, wherein the first spoken language, the second spoken language, or both, are automatically identified.

22. The system of claim 17, wherein the command action identification mechanism is further configured to monitor the command action and identify a synonymic command action phrase.

23. The system of claim 17, wherein the second spoken language matches a configuration of the computer implementing the target application.

24. The system of claim 17, wherein the second spoken language is defined within a user profile.
